(19) United States
(12) Patent Application Publication
(10) Pub. No.: US 2012/0110664 A1
(43) Pub. Date: May 3, 2012

(54) METHOD AND APPARATUS FOR AVOIDING DENIAL OF SERVICE IN WEB-SERVICE BASED SYSTEMS

(75) Inventors: Peter David Niblett, Whitchurch (GB); Lucas William Partridge, Southampton (GB); James Matthew Siddle, Winchester (GB)

(73) Assignee: INTERNATIONAL BUSINESS MACHINES, Armonk, NY (US)

(21) Appl. No.: 12/410,330

(22) Filed: Mar. 24, 2009

Related U.S. Application Data
(60) Provisional application No. 61/144,100, filed on Jan. 12, 2009.

(51) Int. Cl. G06F 21/00

(52) U.S. Cl. 726/22

(57) ABSTRACT

The disclosure relates to a method for identifying and preventing propagation of a DOS attack on a WS-Notification NotificationBroker by inspecting the subscription request. If the address of the NotificationConsumer identified by the subscription request is equivalent to that of the NotificationBroker then the subscription request is rejected.

### CROSS-REFERENCE TO RELATED APPLICATION

This application claims priority to U.S. Provisional Patent Application Ser. No. 61/144,100, filed Jan. 12, 2009.

### BACKGROUND

1. Field of the Invention

The disclosure relates to a method and system for avoiding denial of service in web-service based systems. More specifically, the disclosure relates to a method and apparatus for detecting and preventing attacks to a web-service based notification system.

2. Description of Related Art

Web service based publish-subscribe specifications, such as the Web Services Base Notification (Web Services Base Notification 1.3, Oasis Standard, Oct. 1, 2006) (“WS-BaseNotification”) standard, provide a protocol for web service (or other entity) to establish a subscription. The subscriber issues a request to create a Subscription and this request includes an Endpoint Reference (address) of a Web service termed the NotificationConsumer, and the Subscription results in a stream of event messages being delivered to that NotificationConsumer.

An important feature of this model, which distinguishes it from some other publish-subscribe models (such as Java Message Service), is that it allows third-party subscriptions. That is, the Subscriber and the NotificationConsumer can be different entities. The same capabilities are offered by the WS-Eventing specification protocol (Web Services Eventing, W3C Member Submission, Mar. 15, 2006), although the latter protocol uses the term Event Sink instead of NotificationConsumer.

The WS-Notification family of standards includes another specification called WS-BrokeredNotification. This defines the concept of the NotificationBroker. The NotificationBroker is a Web service which can accept events published by other entities and distribute them to NotificationConsumers that have subscriptions that use the WS-BaseNotification subscription mechanism.

The WS-BaseNotification specification recognizes the potential threat of denial of service (“DOS”) attacks as it states that a malicious Subscriber may request that notifications be sent to a party that is not authorized to receive them. The Subscriber may also mount DOS attacks by requesting large volumes of notifications to be sent to parties that cannot handle them. The protocol suggests countermeasures such as requiring a specific confirmation (opt-in) from NotificationConsumers. However, these suggested countermeasures fail to address attacks after the NotificationConsumers have opted into the system or when the opt-in provision has been waived.

The previous countermeasures are aimed at protecting NotificationConsumers from DOS attacks. However there is also the possibility of a DOS attack being launched against the NotificationBroker itself. The method and apparatus described here is aimed at protecting NotificationBrokers themselves from such DOS attacks. The approach used is to identify and reject self-referencing, or circular, subscription requests at the time they are made.

An alternative approach to prevent a DOS attack on a NotificationBroker would be to apply the so-called hop-count method. This is a well-known method for preventing messages looping around a communications system indefinitely. In this approach a hop-count value (initialized to zero) would be stored in, or associated with, each notification message. Every time a notification message passes through the broker its associated hop-count value would be incremented by one. If an arbitrary pre-defined threshold for the hop-count value is exceeded then the notification would not be retransmitted by the broker. The subscription associated with the repeating notification would be deemed to be circular and appropriate action taken, such as deleting the subscription and logging the error. For reasons described later the embodiment described in this disclosure is superior to the hop-count method.

### SUMMARY

In one embodiment, the disclosure relates to a method for preventing DOS attacks in a web-service based publish-subscription system by: (a) defining a notification source, the notification source generating a notification; (b) sending the notification to a notification broker from the notification source, the notification broker having an address and a list of notification consumers; (c) sending the notification from the notification broker to the notification consumers on the list of notification consumers of the notification broker; (d) preventing the addition of a notification consumer having a same address as the notification broker to the list of notification consumers of the notification broker; and (e) allowing the addition of a notification consumer having an address different than the notification broker to the list of notification consumers of the notification broker.

### BRIEF DESCRIPTION OF THE DRAWINGS

This and other embodiments of the disclosure will be discussed with reference to the following exemplary and non-limiting illustrations, in which like elements are numbered similarly, and where:

FIG. 1 shows an exemplary system for implementing an embodiment of the disclosure by preventing DOS attacks on a NotificationBroker;

FIG. 2 schematically shows a system subject to DOS attack by an external attacker; and

FIG. 3 is a flow diagram illustrating a method of protecting against DOS according to one embodiment of the disclosure.

### DETAILED DESCRIPTION

As discussed, the disclosure relates to a method and system for reducing, if not eliminating, DOS in web-service based notification services. The envisioned attacks are DOS attacks targeted directly or indirectly at NotificationBrokers. For simplicity the exemplary embodiments disclosed herein discuss DOS attacks targeted directly at the NotificationBroker. However the disclosed mechanisms for preventing a DOS attack would also prevent indirect DOS attacks as, for example, when a subscription request is received indirectly from a Subscriber.

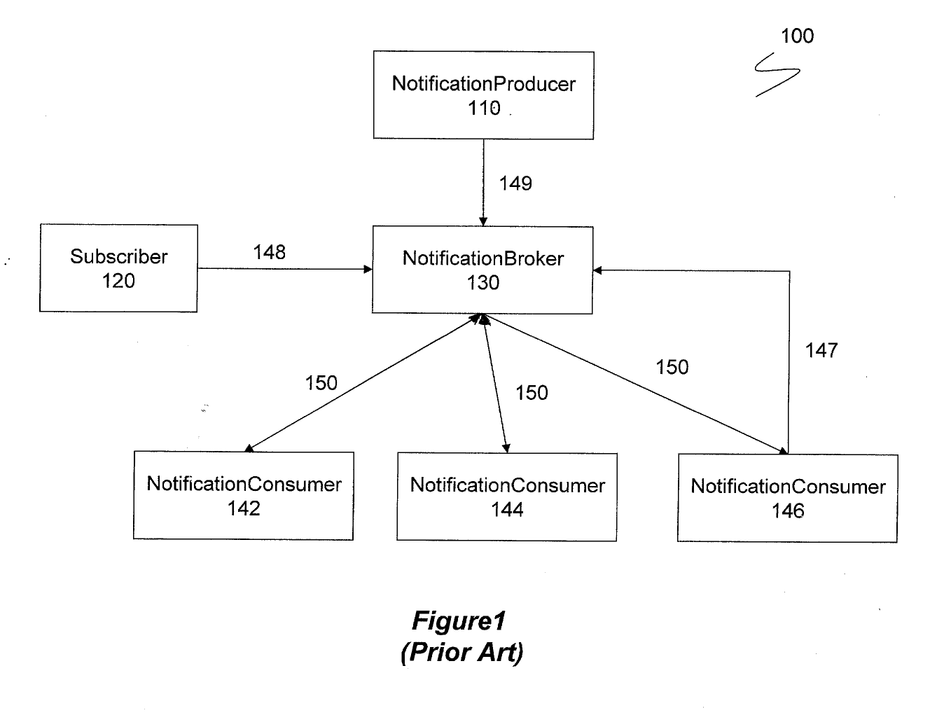

FIG. 1 schematically shows a prior art system for providing Web-service based notification. In FIG. 1, NotificationProducer 110 is a web-based service for providing situation notification indirectly to a plurality of consumers 142, 144 and 146. NotificationConsumers 142, 144 and 146 are also accessible by means of endpoint references which have been subscribed using the WS-Base Notification specification for system 100. NotificationConsumer 146 can directly subscribe to NotificationBroker 130 as shown by arrow 147. Alternatively, the NotificationConsumers can be subscribed indirectly by third party subscriber 120 as shown by arrow 148. In FIG. 1, NotificationConsumers 142 and 144 are subscribed to NotificationBroker 130 by Subscriber 120.

According to the WS-BrokeredNotification specification the NotificationProducer 110 transmits its notifications 149 to the NotificationBroker 130 which then transmits them 150 to NotificationConsumers 142, 144 and 146. This invention concerns itself with preventing DOS attacks on the broker 130.

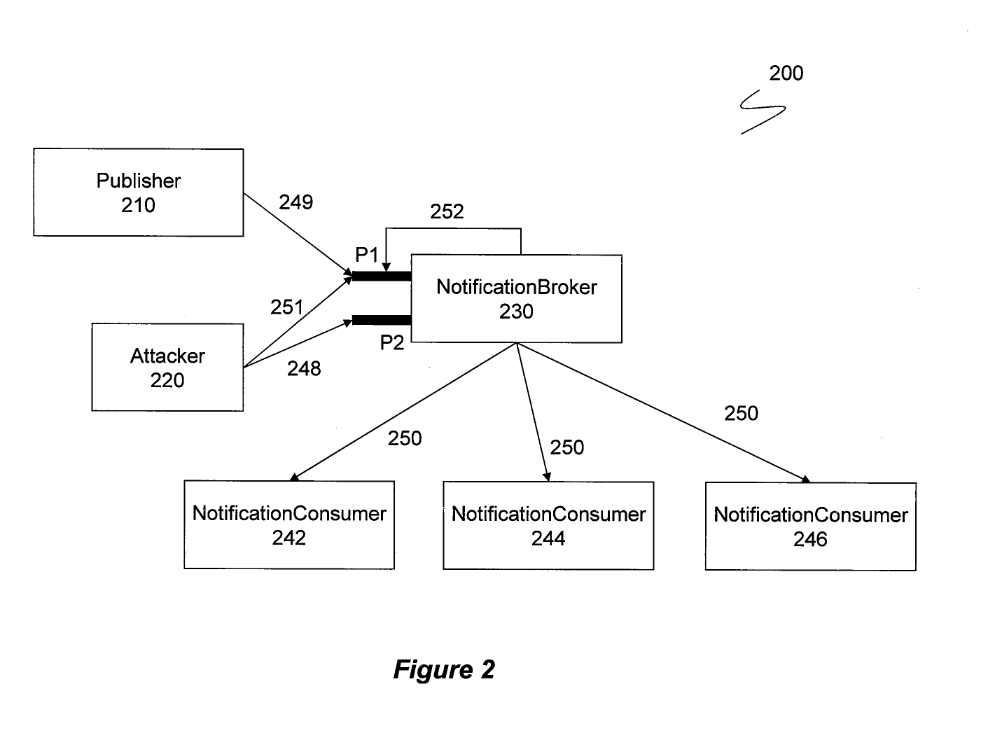

FIG. 2 schematically shows a system subject to DOS attack by an external attacker. In FIG. 2 NotificationBroker 230 comprises Web Services Port 1 (P1) for accepting incoming events 249 from publisher 210. Publisher 210 can be a NotificationProducer. The incoming events can be in the language used by WS-Notification and P1 can implement the NotificationConsumer interface. Port 2 (P2) can accept incoming subscription requests from subscribers. While P1 and P2 are shown as different ports of NotificationBroker 230, they can define the same port. That is, NotificationBroker 230 can have one port dedicated to all external interfaces.

In one embodiment of the disclosure, malicious or misguided attacks from attacker 220 are implemented by sending circular subscription requests 248 to P2. In a circular subscription attack, attacker 220 submits a single subscription 248 to P2 on the NotificationBroker 230. Unlike a regular subscription request however this subscription request identifies the NotificationBroker 230 as a NotificationConsumer. Attacker 220 will then publish a message to P1 as shown by arrow 251. Because P1 has already been identified as the NotificationConsumer, the NotificationBroker 230 will republish the message back to P1, as shown by arrow 252. The notification will be repeatedly published ad-infinitum wasting processing resources on the NotificationBroker server. Tying the NotificationBroker's resources will hamper its ability to forward notifications 250 from Publisher 210 to NotificationConsumers 242, 244 and 246.

Note that the sending of a notification message 251 by the attacker 220 is not necessary to trigger the circular notifications 252. Provided the attacker 220 subscribes the broker to the same topic the publisher 210 publishes on, then even a message 249 sent by the publisher 210 will trigger the circular notifications.

Section 4.2 of WS-Base Notification states that the sending of two identical subscribe messages to a NotificationProducer must result in the creation of two subscriptions. In this case the NotificationBroker will produce two copies of the notification message for the consumer. Thus, if attacker 220 has sent two or more identical subscribe requests, the sending of a single notification message to NotificationBroker will unleash a chain reaction where the broker is expected to handle an exponentially increasing number of notification messages. NotificationBroker 230 will end up with an ever-increasing backlog of work to perform and it is likely to run out of resources or hit some internal implementation limits. Consequently, innocent users of the broker service will suffer.

To address this and other DOS attacks, an embodiment of the disclosure relates to programming NotificationBroker 230 to examine subscription requests and reject any subscription request which identify the NotificationBroker as the consumer of the subscription. The circular or self-referencing subscription can have no useful purpose. The circular subscription can be caused by erroneous subscribers. Alternatively, the circular subscription can be caused by malicious attackers aiming to interrupt the operation of the service.

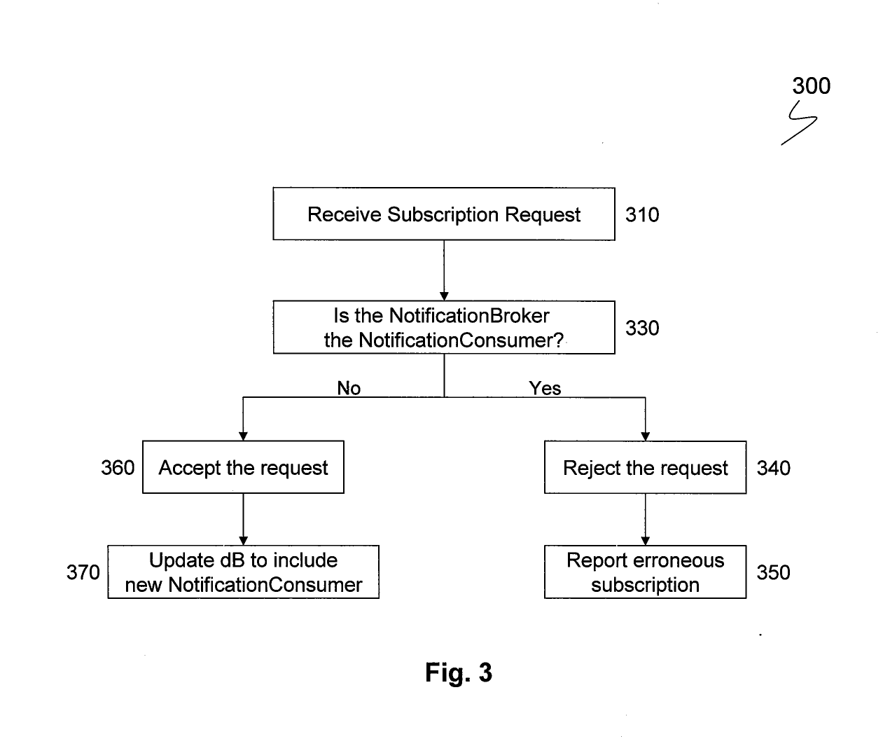

FIG. 3 is a flow diagram illustrating a method of protecting against DOS attacks according to one embodiment of the disclosure. Flow diagram 300 starts at step 310 wherein the NotificationBroker receives a subscription request. In step 330, a determination is made as to whether the NotificationConsumer identified in the subscription request is actually the NotificationBroker itself. If the NotificationBroker is also the NotificationConsumer, then in step 340 the subscription request is rejected and in step 350 the erroneous or malicious subscription request is reported. Optionally, the source of the request can be identified as a suspect source.

If the NotificationConsumer is not the same as the NotificationBroker, then the request is allowed to proceed to step 360. In step 370 the NotificationBroker's database is updated to include the new NotificationConsumer as a legitimate endpoint reference.

Returning to the hop-count method described in paragraph [0008] the embodiment described herein is superior in at least two respects. First, with the hop-count method, additional information (the hop-count value) must be stored in, or associated with, every notification message. Second, depending on how the hop-count method has been configured, the broker may needlessly process an enormous number of notification messages before the associated circular subscription has been identified. For example, consider a scenario where the hop-count threshold for notification messages is 10 and an attacker has created 200 malicious, self-referencing subscriptions. If the attacker then publishes a single message to the broker, the broker will transmit 200 outgoing messages to itself with a hop-count value of 1, each of which in turn will result in 200 new outgoing messages with a hop-count value of 2, and so on. The original subscription request may then result in well over 200⁹ notification messages being transmitted before one of the notification messages hits the hop-count limit.

In contrast, the disclosed embodiment ensures that a circular subscription is detected and rejected right at the moment of subscription, when performance is less critical than at the time of notification.

The disclosed embodiment is limited to attacks where the circular subscription is contained within a single broker, and does not cover more advanced attacks that attempt to set up circular subscriptions between brokers (e.g., NotificationBroker A subscribes to NotificationBroker B and NotificationBroker B subscribes to NotificationBroker A).

It has been discovered that multi-broker attacks are better tackled by a hop-count approach or by detecting and responding to abnormal levels of network traffic. Note that the single NotificationBroker attack can cause a NotificationBroker to loop without generating additional traffic because the notification messages are sent and received by the same machine.

As stated, the NotificationBroker can detect and reject self-referencing circular subscription requests. Depending on how the subscription is established, there can be other variations to the disclosed principles. For example, the WS-BrokeredNotification specification defines three ways in which the Notification Broker can receive events from publisher. A NotificationBroker is free to implement any combination of the following:

First, the NotificationBroker advertises a “service point” via some mechanism, and the Publisher sends events to this Service Point using the Notify operation. The Service Point can be advertised as a WS-Addressing Endpoint Reference. An Endpoint Reference or EPR contains a transport address if the transport is HTTP. This address is a URL together with zero or more reference parameters. The Publisher sends its event Notify message to the transport address given in the EPR and if the EPR contains any reference parameters, the publisher can insert these into the SOAP message header.

Second, the NotificationBroker can itself be a subscriber with a pre-administered subscription to a known NotificationProducer. When the NotificationBroker starts it creates a subscription to the NotificationProducer and receives events via that subscription, which it then distributes to NotificationConsumers that are subscribed to it. WS-Notification refers to this as broker-initiated publishing.

Third, a Publisher can register itself with the NotificationBroker and provide the Endpoint Reference of a source of events (NotificationProducer) and then the NotificationBroker dynamically subscribes to that NotificationProducer and proceeds as in the second method identified above. This method has also been referred to as demand-based publishing.

If the NotificationBroker provides the mechanism described in paragraph [0029] then it can implement the disclosed principles by examining the NotificationConsumer EPR that is provided in the Subscribe request message, and testing to determine whether the EPR matches (is equivalent to) the Service Point used to accept the Notify message. The WS-Addressing specification does not define a general set of rules for testing two EPRs to determine equivalence. In one embodiment, the EPR in the Subscribe request is tested (using known information about the NotificationBroker deployment) to see if a hypothetical notification message sent to that EPR would end up being processed by the NotificationBroker Service Point itself. If the service point does not use reference parameters, then this is simply a question of looking at the EPR's address and comparing it against the URL of the Service Point. The comparison step is important as a malicious subscriber might try to disguise the address, by passing in an “equivalent” URL. For example, suppose that the NotificationBroker service is listening on:

http://example.or_svc70spO1NB/NotificationBroker. All of the following URLs are equivalents:

http://example.org:80/svc70spOINB/NotificationBroker

http://example.or/svc70spo1NB/NotificationBroker

http://example.ORg/svc7OspOINB/NotificationBroker

http-//example,org/svc70sp%30%31/NotificationBroker

Section 6 of the IETF RFC that defines the syntax of URLs contains some normalization rules which can be used to identify equivalent addresses. The NotificationBroker should also check for URLs that contain dotted decimal IP addresses instead of hostnames, or for situations where alias host names are being used, e.g., localhost. The WS-Addressing specification allows the address part of the EPR to be an Internationalized Resource Identifier or IRI. Thus, if the NotificationBroker supports IRIs then it should use the comparison techniques described therein.

If the NotificationBroker is relying on the presence of additional Reference Parameters to distinguish itself from any other service (including other Notification Broker instances) running on the same endpoint address, then it can also examine the Reference Parameter section of the Subscribe Request's EPR to determine if these are sufficient to route any notification message to itself.

If the NotificationBroker supports demand-based publishers (paragraph [0031]) there is the possibility of a variation of the attack where a malicious Publisher supplies the address (EPR) of the NotificationBroker instead of its own address and thus tricks the NotificationBroker into creating a circular subscription by subscribing to itself. To protect against this the NotificationBroker should test the RegisterPublisher request to see if the PublisherReference EPR that it contains is equivalent to the EPR on which the Broker accepts Subscribe requests, and reject the RegisterPublisher request if it is equivalent. The equivalence tests need to follow the rules described in [0032] to [0039].

Pre-administered subscriptions (paragraph [0030]) may not provide any further opportunity for malicious third-party DOS attacks since these subscriptions are created by the administrator. However an administrator can erroneously configure a subscription to the NotificationBroker itself so the NotificationBroker administration code should do a check similar to that described in [0032] to [0039].

While the inventive principles disclosed herein have been illustrated in the context of a WS-Brokered Notification and NotificationBroker, the inventive principles are not limited thereto and can be applied to other publish/subscribe or even point-to-point messaging systems. For example, consider the general situation where a message addressed to point B arrives at an intermediate point A which in turn triggers the transmission of the same or another message onwards to its final destination, point B. (Note that the second message need not be sent directly from point A itself.) The embodiment described herein simply checks to ensure that the address of B is not equivalent to the address of A. Otherwise point A will keep sending the message to itself. While the principles of the disclosure have been illustrated in relation to the exemplary embodiments shown herein, the principles of the disclosure are not limited thereto and include any modification, variation or permutation thereof.

1. In an internet messaging system using a method for preventing denial of service attacks in a single broker web-service based publish-subscription system comprising:
providing a processor for storing a URL with instructions for defining a notification source, the notification source generating a notification;
sending the notification to a notification broker from the notification source, the notification broker having an address and a list of notification consumers;
sending the notification from the notification broker to the notification consumers on the list of notification consumers of the notification broker;
preventing the addition of a notification consumer having a same address as the notification broker to the list of notification consumers of the notification broker; and
allowing the addition of a notification consumer having an address different than the notification broker to the list of notification consumers of the notification broker.
